(19) United States
(12) Patent Application Publication
(10) Pub. No.: US 2018/0015579 A1
(43) Pub. Date: Jan. 18, 2018

(54) GRINDING MACHINE FOR GRINDING OF A PROFILE

(71) Applicants: KAPP Werkzeugmaschinen GmbH, Coburg (DE); NILES Werkzeugmaschinen GmbH, Berlin (DE)

(72) Inventor: Matthias SCHMIDT, Rammingen (DE)

(21) Appl. No.: 15/631,370

(22) Filed: Jun. 23, 2017

(30) Foreign Application Priority Data
Jul. 13, 2016 (DE) 20 2016 004 284.0

(51) Int. Cl. B23Q 1/01; B23Q 39/02; B23F 23/12; B23Q 1/26; B23Q 39/00

(52) U.S. Cl. CPC B23Q 1/015; B23Q 1/017; B23Q 39/022; B23F 23/1225; B23Q 2039/002; B23Q 1/26

(57) ABSTRACT

A grinding machine for grinding of a profile, comprising a machine bed, wherein a machining device is arranged on the machine bed, wherein the machining device comprises a swivel head which carries a first grinding spindle with a first grinding tool, especially with a roughing grinding tool, and a second grinding spindle with a second grinding tool, especially with a finishing grinding tool, wherein a workpiece carrier being a rotary table is arranged on the machine bed. To allow the production of workpieces with a complex geometry in a high precision in an economical manner the invention proposes that the swivel head further carries at least one third grinding spindle with a third grinding tool, wherein the swivel axle of the swivel head is directed horizontally and the axis of rotation of the rotary table is directed vertically.

### CROSS-REFERENCE TO RELATED APPLICATIONS

The present application claims priority of DE 20 2016 004 284.0, filed Jul. 13, 2016, the priority of this application is hereby claimed and this application is incorporated herein by reference.

### BACKGROUND OF THE INVENTION

The invention relates to a grinding machine for grinding of a profile, comprising a machine bed, wherein a machining device is arranged on the machine bed, wherein the machining device comprises a swivel head which carries a first grinding spindle with a first grinding tool, especially with a roughing grinding tool, and a second grinding spindle with a second grinding tool, especially with a finishing grinding tool, wherein a workpiece carrier being a rotary table is arranged on the machine bed.

Grinding machines of the generic kind are well known in the state of the art. A rotary table is arranged on a machine bed which serves for the reception of a workpiece which is to be ground. The machining of the workpiece takes place by means of grinding spindles which are equipped with different grinding tools, especially at the one hand with a roughing grinding wheel and at the other hand with a finishing grinding wheel. Alternatively to grinding wheels the use of worm-shaped grinding tools is known.

Normally, on such a machine only the machining of a non-planar profile takes place. Other surfaces, especially cylindrical or frontal planar surfaces of the workpiece, are machined (normally prior grinding of the profile) on respective circular or surface grinding machines.

In some applications such high requirements with respect to the precision of the geometry of the workpiece are given that already problems can occur at the change of the workpiece from one of the grinding machines to the other. As an example for that parts of a cycloidal gear should be mentioned which have a profile which must be produced with a very high precision especially relatively to a cylindrical peripheral surface and bore of the part.

Known grinding machines provide not yet sufficient possibilities to produce such precise parts reproducible and economical.

DE 10 2014 203 402 B3 discloses a grinding machine by which axial bores and plane outer surfaces on both sides can be ground. From DE 196 42 975 A1 a turret of a machine tool with a plurality of tools is known. DE 10 2006 026 184 A1 shows a turning centre. From DE 203 18 660 U1 a machine tool for milling, grinding and polishing is known, wherein a plurality of tools can be brought in engagement by means of a guiding device.

### SUMMARY OF THE INVENTION

It is the object of the invention to further develop a grinding machine of the generic kind so that it becomes possible to produce workpieces with a complex geometry with a high precision and in an economical manner.

The solution of the object by the invention is characterized in that the swivel head of the machine further carries at least one third grinding spindle with a third grinding tool beside the two above mentioned grinding spindles, wherein the swivel axle of the swivel head is directed horizontally and the axis of rotation of the rotary table is directed vertically.

The third grinding tool is preferably such a tool by which a cylindrical area of the workpiece can be machined. For doing so especially such a grinding wheel is used which has a rectangular shape in a radial cross section and which thus has such a profile by which said cylindrical area can be ground. Just as well a plane face area of the workpiece can also be ground with said grinding wheel.

Preferably it is provided that the swivel axle of the swivel head and the axis of rotation of the rotary table are arranged in a common plane.

The first grinding tool and the second grinding tool are preferably designed as profile tools for grinding of a non-planar contour while the third grinding tool—as already mentioned above—is designed as grinding tool for grinding of a cylindrical surface of the workpiece which has to be ground. A preferred embodiment of the invention provides that the first grinding spindle and the second grinding spindle are designed as rod-shaped or tubular parts (thus as grinding arm) with a common longitudinal axis which extend to opposite sides from a centre region of the swivel head. The centre region is arranged close to the axis of rotation of the swivel head. The axis of rotation of the first grinding tool and the axis of rotation of the second grinding tool are preferably perpendicular to the mentioned longitudinal axis.

The third grinding spindle comprises preferably as well a longitudinal axis which intersects perpendicular the longitudinal axis of the first and second grinding spindle. The longitudinal axis of the third grinding spindle is thereby preferably at once the axis of rotation of the third grinding tool. Thereby, it is preferably provided that the first grinding spindle, the second grinding spindle and the third grinding spindle form a T-shaped structure.

The swivel head carries preferably furthermore a measuring element. A preferred embodiment of the invention provides that the first, the second and the third grinding spindle as well as the measuring element form a crosswise structure seen in horizontal direction (direction of the swivel axle of the swivel head). Thereby, the measuring element is preferably pencil-shaped with a sensor element at one axial end.

The proposed grinding machine has furthermore preferably a fourth grinding spindle with a fourth grinding tool which is used for grinding of a plane face area of the workpiece.

It becomes possible with the explained design of a grinding machine to machine complex profiles as well as cylindrical and plane areas of a workpiece respectively in one clamping. So, a higher precision can be obtained which cannot be reached by other means.

The employed swivel head is designed as precision rotary table.

Thus thereby, preferably and specifically beneficial, profiles and cylindrical areas can be machined at once as they are required for parts of cycloidal gears. Furthermore, it is if applicable also possible to grind plane face areas in the same clamping in which the profiles are ground.

Preferably—as depicted—profile grinding wheels are provided for the grinding of the profile. Alternatively, it can also be provided to use grinding worms instead.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows in perspective view a grinding machine and

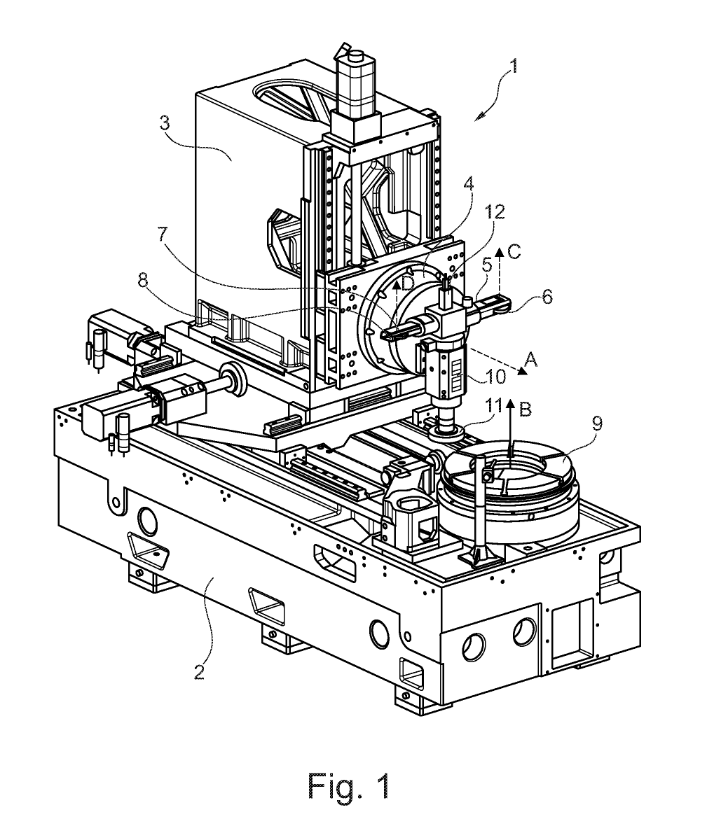

FIG. 2 shows in perspective view an enlargement of the workspace of the grinding machine according FIG. 1.

### DETAILED DESCRIPTION OF THE INVENTION

In the figures a grinding machine 1 is shown on which a so-called needle ring of a cycloidal gear (not depicted) is finished in the embodiment. The grinding machine 1 has a machine bed 2 which carries a machining device 3. Furthermore, the grinding machine 1 has a rotary table 9 for the reception of a (not depicted) workpiece. The axis of rotation of the rotary table 9 is arranged vertically.

The machining device 3 can be moved translational in the direction to or away from the rotary table 9 to bring grinding tools with the workpiece in engagement. The machining device 3 has as an essential part a swivel head 4 which can be pivoted around a swivel axle A; the swivel axle A is oriented horizontally.

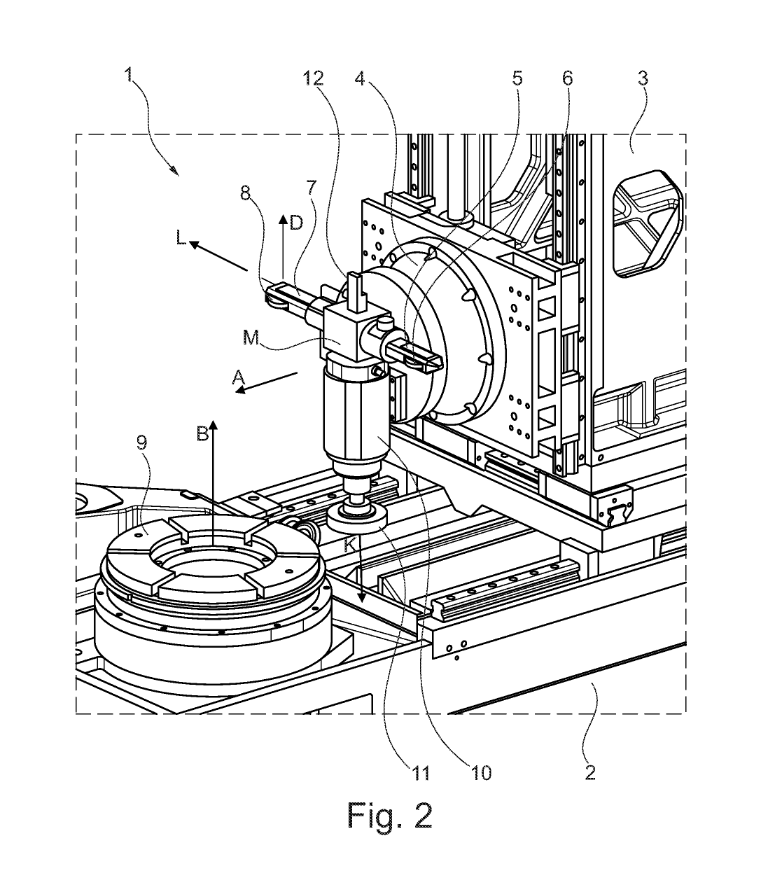

The swivel head 4 comprises, which can be seen best from FIG. 2, three grinding spindles, namely a first grinding spindle 5, a second grinding spindle 7 and a third grinding spindle 10. Each grinding spindle 5, 7, 10 carries respectively a grinding tool 6, 8 and 11. The first grinding tool 6 is a profile grinding wheel for roughing of a profile of the workpiece, the second grinding tool 8 is a profile grinding wheel for finishing of the mentioned profile. The third grinding tool 11 is a grinding wheel by which a cylindrical outer circumference area of the workpiece can be ground.

As can be seen the axes of rotation C and D of the first and of the second grinding tool 6 and 8 are arranged parallel to another; the two grinding spindles 5 and 7 are designed as tubular grinding arms which carry in their axial end region the respective grinding tools 6, 8. The two grinding arms extend from a centre region M of the swivel head 4 to opposite directions; however they have the same longitudinal axis L.

The third grinding spindle 10 comprises a longitudinal axis K; at the end of the grinding spindle 10 the third grinding wheel 11 is arranged.

Furthermore, a measuring element 12 in the form of a measuring key button is arranged at the swivel head 4.

As results from the figures the three grinding spindle 5, 7 and 10 as well as the measuring element 12 form a crosswise structure, seen in horizontal direction and in the direction of the axis A respectively.

Thus, the following possibility of machining results:

At first, a workpiece which is clamped on the rotary table 9 can be cylindrical ground with the grinding wheel 11 at its outer circumference. Correspondingly, of course also a respective machining of an inner circumference area is possible.

At this machining the swivel head 4 is in the position as be shown in the figures.

By a subsequent pivoting of the swivel head 4 around 90° the first grinding wheel 6 can be prepared for roughing of the profile (in the single dividing process). Thereby, the profile can be rough machined. After roughing of the profile the swivel head 4 is pivoted by 180° so that the second grinding wheel 8 is brought in the machining position for finishing of the profile.

After the finishing a measurement by means of the measuring element 12 can occur wherefore the swivel head 4 is pivoted by 180° from the position which is shown in the figures.

Of course, the order of the machining—with respect to the round grinding and the profile grinding—can also be done in a different manner.

The swivel head 4 is designed as precision rotary table which makes it possible that all relevant fine machining operations are carried out in one clamping of the workpiece. A change of the clamping of the workpiece is thus redundant and is the precondition for increasing the machining precision to a high level.

This is promoted also by the crosswise structure of the mentioned elements at the swivel head 4 which allows an effective and economical production.

If applicable—and this is not specifically depicted in the figures—also a surface grinding of the face of the workpiece can be carried out in the same clamping on the rotary table 9.

While specific embodiments of the invention have been shown and described in detail to illustrate the inventive principles, it will be understood that the invention may be embodied otherwise without departing from such principles.

I claim:

1. A grinding machine for grinding of a profile, comprising a machine bed, wherein a machining device is arranged on the machine bed,
wherein the machining device comprises a swivel head which carries a first grinding spindle with a first grinding tool, especially with a roughing grinding tool, and a second grinding spindle with a second grinding tool, especially with a finishing grinding tool,
wherein a workpiece carrier being a rotary table is arranged on the machine bed,
wherein the swivel head further carries at least one third grinding spindle with a third grinding tool, wherein the swivel axle of the swivel head is directed horizontally and the axis of rotation of the rotary table is directed vertically.

2. The grinding machine according to claim 1, wherein the swivel axle of the swivel head and the axis of rotation of the rotary table are arranged in a common plane.

3. The grinding machine according to claim 1, wherein the first grinding tool and the second grinding tool are designed as profile tools for grinding of a non-planar contour and that the third grinding tool is designed as grinding tool for grinding of a cylindrical or planar surface of the workpiece which has to be ground.

4. The grinding machine according to claim 3, wherein the first grinding spindle and the second grinding spindle are designed as rod-shaped or tubular parts with a common longitudinal axis which extend to opposite sides from a centre region of the swivel head.

5. The grinding machine according to claim 4, wherein the axis of rotation of the first grinding tool and the axis of rotation of the second grinding tool are perpendicular to the longitudinal axis.

6. The grinding machine according to claim 4, wherein the third grinding spindle comprises a longitudinal axis which intersects perpendicular the longitudinal axis of the first and second grinding spindle.

7. The grinding machine according to claim 6, wherein the longitudinal axis of the third grinding spindle is the axis of rotation of the third grinding tool.

8. The grinding machine according to claim 7, wherein first grinding spindle, the second grinding spindle and the third grinding spindle form a T-shaped structure.

9. The grinding machine according to claim 5, wherein the swivel head carries furthermore a measuring element.

10. The grinding machine according to claim 9, wherein the first, the second and the third grinding spindle as well as the measuring element form a crosswise structure seen in the direction of the swivel axle of the swivel head.
